(19) United States
(12) Patent Application Publication
(10) Pub. No.: US 2010/0084076 A1
(43) Pub. Date: Apr. 8, 2010

(54) Process and plant for producing tyres for vehicle wheels

(75) Inventor: Fiorenzo Mariani, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: PIRELLI TYRE S.p.A., Milan (IT)

(21) Appl. No.: 12/448,344

(22) PCT Filed: Dec. 22, 2006
(86) PCT No.: PCT/IB2006/004176

§ 371 Date: Jun. 18, 2009

(51) Int. Cl. B29D 30/00; B29C 35/02

(52) U.S. Cl. 156/111; 156/396

(57) ABSTRACT

A plant and a process for producing tyres for vehicle wheels. The process includes the steps of: a) building green tyres on respective toroidal supports in at least one building line of a tyre production plant; b) transferring a first green tyre and the relevant toroidal support to a moulding and vulcanization unit of at least a first vulcunization line of a vulcanization station of the production plant, the first vulcanization line being provided with a first device for transferring the toroidal support; c) transferring a second green tyre and the relevant toroidal support to a moulding and vulcanization unit of at least a second vulcanization line of the vulcanization station of the production plant, the second vulcanization line being different from the first vulcanization line and being provided with a second transfer device different from the first transfer device; d) moulding and vulcanizing the first green tyre in the moulding and vulcanization unit of the first vulcanization line for a first time interval and the second green tyre in the moulding and vulcanization unit of the second vulcanization line for a second time intercal different from the first time interval, wherein at least one between steps b) and c), is preceded by a step j) of transporting at least one of the green tyres and the relevant toroidal support into a holding unit operatively interposed between the first vulcanization line and the second vulcanization line.

The present invention relates to a process for producing tyres for vehicle wheels.

In particular, the present invention relates to a process for producing tyres built on a toroidal support.

The invention also relates to a plant for producing tyres for vehicle wheels, able to be used for transporting out the aforementioned producing process.

Production cycles of a tyre provide that, after a building process wherein the various components of the same tyre are made and/or assembled in a building line, a moulding and vulcanization process is carried out, in a suitable vulcanization line, adapted for defining the tyre structure according to a desired geometry and tread pattern.

A tyre generally comprises a toroidally ring-shaped carcass including one or more carcass plies, strengthened with reinforcing cords lying in substantially radial planes (a radial plane contains the rotation axis of the tyre). Each carcass ply has its ends integrally associated with at least one metal reinforcing annular structure, known as bead core, constituting the reinforcing at the beads, i.e. at the radially inner ends of the tyre, having the function of enabling the assembling of the tyre with a corresponding mounting rim. Placed crown wise to said carcass is a band of elastomeric material, called tread band, within which, at the end of the moulding and vulcanization steps, a raised pattern is formed for ground contact. A reinforcing structure, generally known as belt structure, is arranged between the carcass and the tread band. Such structure usually comprises, in the case of car tyres, at least two radially superposed strips of rubberised fabric provided with reinforcing cords, usually of metal material, arranged parallel to each other in each strip and in a crossed relationship with the cords of the adjacent strip, preferably symmetrically arranged with respect to the equatorial plane of the tyre. Preferably, the belt structure further comprises at a radially outer position thereof, at least on the ends of the underlying belt strips, also a third layer of textile or metallic cords, circumferentially disposed (at zero degrees).

Finally, in tyres of the tubeless type, that is devoid of an air tube, a radially inner layer, called liner, is present which has imperviousness features for ensuring the air-tightness of the tyre itself.

To the aims of the present invention and in the following claims, by the term “elastomeric material” it is intended a composition comprising at least one elastomeric polymer and at least one reinforcing filler. Preferably, such composition further comprises additives such as cross-linking and/or plasticizing agents. By virtue of the cross-linking agents, such material may be cross-linked by heating, so as to form the final manufactured article.

In the present context, by the term “green tyre” it is indicated a tyre obtained by the building process and not vulcanized yet.

In recent times, tyre production processes in which a green tyre is built on a rigid toroidal support have been introduced in the field. Said processes are preferably used for tyres produced starting from a limited number of elementary semifinished products fed onto said toroidal support whose outer profile coincides with that of the radially inner surface of the tyre to be produced. The toroidal support is moved, preferably by means of a robotized plant, among a plurality of working stations in each of which a particular building step of the tyre is carried out, through automated sequences. At the end of the building steps, the toroidal support with the green tyre supported thereby is arranged inside a vulcanization mould.

An example of the above processes is described in WO 01/32409, in the name of the same Applicant, which illustrates a tyre building line provided with working stations, each arranged to make and assemble at least one structural component of the tyre being processed, wherein at least one series of tyres, comprising at least a first and a second model of tyres that are different from each other, is treated simultaneously, and wherein the transferral of the tyres to the vulcanization line is carried out through robotized arms and according to a transferring rate which is equal to the transferring rate of the tyres to each of said working stations.

On the other hand, WO 01/39963, in the name of the same Applicant, illustrates a process for producing tyres that are different from each other, comprising a building unit having a plurality of working stations, each adapted for assembling at least one structural component on at least one type of tyre being processed, a vulcanization unit, and a device for transferring and moving the tyre being processed, operating between the working stations and the vulcanization unit. Said device for transferring and moving the tyre transfers a green tyre to the vulcanization unit; after vulcanization, it picks up a vulcanized and moulded tyre from the vulcanization unit and moves it to the first working station of the building unit, where the tyre is removed from the corresponding toroidal support. The latter is then moved by the same device for transferring and moving the tyre into a temperature stabilizing device. If the tyre to be produced requires a toroidal support of a different type, the same device picks up the suitable toroidal support from a feeding station and introduces it into the temperature stabilizing device.

EP 1424182 illustrates an apparatus comprising two vulcanizing plants arranged side by side, each comprising a plurality of vulcanizing stations arranged on an arc within a plane. Each station comprises a vulcanizing mould, a mould opening/closing apparatus and a set of tyre transfer devices arranged in central position with respect to the arc and including a rotating arm for loading a green tyre and discharging a vulcanized tyre from each vulcanizing mould.

The Applicant has verified that in the production plants of the type described in EP 1 424 182, that is, provided with two vulcanization lines, the management of two or more vulcanization cycles with different times causes problems in synchronising the opening/closing steps of the vulcanization moulds and thus problems in the general management of the production plant with negative consequences on productivity.

On the other hand, the increase of the production capacity achieved by modern tyre production processes and plants, like those described in WO 01/32409 and WO 01/39963, has implied the need of providing the simultaneous vulcanization of tyres with different vulcanization times within the same vulcanization plant.

The Applicant has noted that in the above described processes and plants the management of tyres with different vulcanization times causes an unavoidable decrease of the productivity since it is necessary to complete a first vulcanization cycle with a predetermined vulcanization time and therefore a predetermined frequency before setting a second cycle with different vulcanization time and frequency. As an alternative, the tyres that require a vulcanization time different from that set in the first cycle are overvulcanized or, on the contrary, only partly vulcanized and therefore not commercialisable. In both cases, there occurs an undesired decrease of the production cycle efficiency.

The Applicant has therefore perceived that in order to increase the productivity keeping the production cycle efficiency unchanged it is necessary to have production plants provided with at least two vulcanization lines programmable with different times.

The applicant has further understood that having two vulcanization lines operatively independent one from the other it is advantageously possible to prevent the spreading of any anomalies or faults from the one to the other of the two lines.

The Applicant has therefore found that having a production plant comprising at least two vulcanization lines, each provided with a device for transferring the tyres, which are programmable with different vulcanization times, and with a holding unit operatively interposed between said lines, it is possible to obtain a flexible tyre production plant and process capable of buffering any faults and/or anomalies.

In accordance with a first aspect thereof, the invention relates to a process for producing tyres for vehicle wheels comprising the steps of:

a) building green tyres on respective toroidal supports in at least one building line of a tyre production plant;

b) transferring a first green tyre and the relevant toroidal support to a moulding and vulcanization unit of at least a first vulcanization line of a vulcanization station of the production plant, said first vulcanization line being provided with a first device for transferring the toroidal support;

c) transferring a second green tyre and the relevant toroidal support to a moulding and vulcanization unit of at least a second vulcanization line of the vulcanization station of the production plant, said second vulcanization line being different from the first vulcanization line and provided with a second transfer device different from the first transfer device;

d) moulding and vulcanizing the first green tyre in the moulding and vulcanization unit of the first vulcanization line for a first time interval and the second green tyre in the moulding and vulcanization unit of the second vulcanization line for a second time interval different from the first time interval;

wherein at least one between steps b) and c), is preceded by a step j) of transporting at least one of said green tyres and the relevant toroidal support into a holding unit operatively interposed between said first vulcanization line and said second vulcanization line.

Said process, providing tyre transfers in two or more operatively independent vulcanization lines wherein tyres may be treated with different vulcanization times, and tyre transfers in holding units operatively interposed between said vulcanization lines, allows obviating the above problems of synchronism in the various operating steps.

The process according to the present invention therefore is flexible and efficient.

Preferably, after step d), said process comprises the steps of:

e) transferring the moulded and vulcanized tyres with the respective toroidal supports in a respective tyre removal unit of the respective vulcanization line by the respective transfer devices;

f) separating the moulded and vulcanized tyres from the relevant toroidal supports.

Even more preferably, after step f), said process comprises the steps of:

g) transferring the toroidal supports in a respective cooling unit of the respective vulcanization line by means of the respective transfer devices;

h) cooling said toroidal supports.

Preferably, step e) is preceded by a step j′) of transporting one of said moulded and vulcanized tyres and the relevant toroidal support into a holding unit operatively interposed between said first vulcanization line and said second vulcanization line.

Even more preferably, step g) is preceded by a step j″) of transporting one of said toroidal supports into a holding unit operatively interposed between said first vulcanization line and said second vulcanization line.

By providing multiple transport steps of the tyres into the holding unit, it is in fact possible to achieve an even more flexible process and capable of better buffering any anomalies of the production process.

Advantageously, the transport steps of the supports in input and/or in output from the vulcanization station are carried out by at least one specific device for handling the toroidal supports to and from the vulcanization station.

In this way, the number of operations carried out by the transfer devices is limited, with consequent improvement of the vulcanization station management.

For the same reason, step f) is preferably carried out by a specific handling device. This also allows having a device specialised for transporting out the specific step.

In accordance with a second aspect thereof, the invention relates to a plant for producing tyres for vehicle wheels comprising:
at least one building line for green tyres on respective toroidal supports;
at least one vulcanization station comprising a first vulcanization line and a second vulcanization line, each vulcanization line comprising at least one tyre moulding and vulcanization unit;

wherein said vulcanization station comprises:
at least one holding unit of toroidal supports operatively interposed between said first vulcanization line and said second vulcanization line;
at least a first transfer device comprised in said first vulcanization line for transferring a toroidal support between said at least one moulding and vulcanization unit of said first tyre vulcanization line and said holding unit;
at least a second transfer device comprised in said second vulcanization line for transferring a toroidal support between said at least one moulding and vulcanization unit of said second tyre vulcanization line and said holding unit.

Thanks to the presence of a holding unit operatively interposed between a first vulcanization line and a second vulcanization line, which are operatively independent one from the other and provided with own transfer devices, the plant of the present invention allows treating tyres with different vulcanization times without presenting the disadvantages described above.

Preferably, the production plant comprises at least one unit for removing the moulded and vulcanized tyre from the respective toroidal support and at least one unit for cooling said toroidal support.

In that case, said at least one first transfer device is adapted for transferring said toroidal support among at least two of: said at least one moulding and vulcanization unit, said at least one removal unit, said at least one cooling unit of said first vulcanization line, and said holding unit; and said at least one second transfer device is adapted for transferring said toroidal support among at least two of said at least one moulding and vulcanization unit, said at least one removal unit, said at least one cooling unit of said second vulcanization line, and said holding unit.

Advantageously, said moulding and vulcanization units comprise at least one moulding and vulcanization turntable adapted for housing at least six vulcanization moulds. In fact, in this way it is possible to optimise the production on the basis of the vulcanization times required for the tyres to be produced.

Further features and advantages of invention will be clear from the following description of some preferred examples of production plants and processes according to the invention, made by way of indicating and non-limiting purpose with reference to the annexed drawings, wherein:

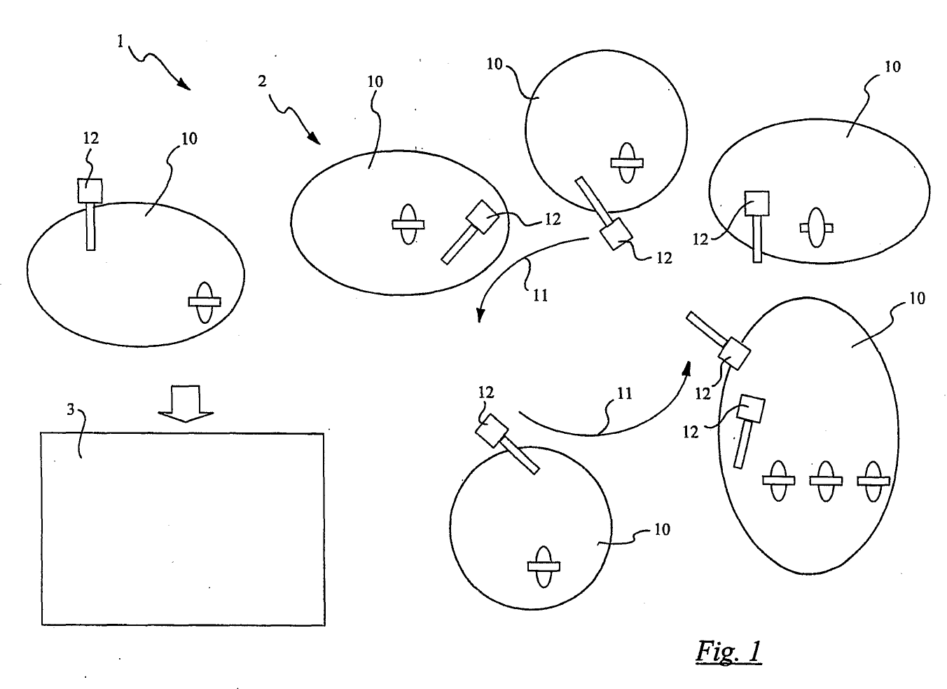

FIG. 1 shows a schematic layout of a plant for producing tyres for vehicle wheels wherein the process according to the present invention is carried out; and

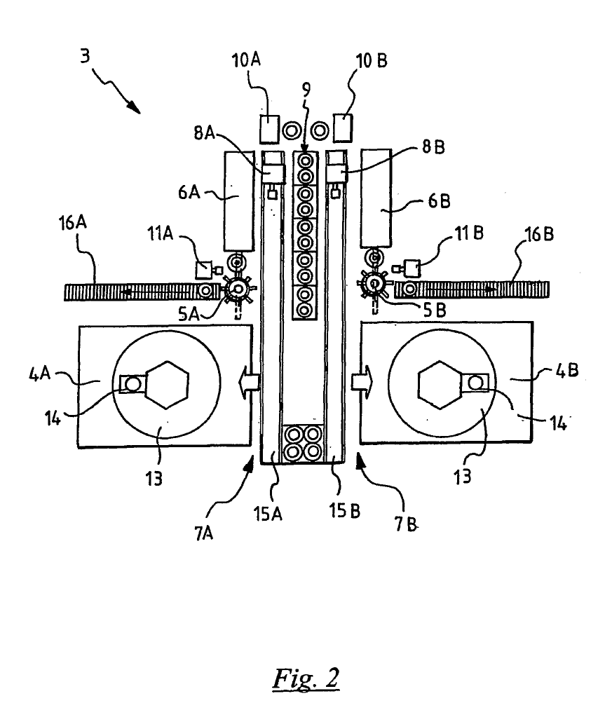

FIG. 2 shows a schematic plan view of a vulcanization station according to one embodiment of the present invention.

With reference to FIG. 1, by reference numeral 1 it is generally indicated a plant for producing tyres for vehicle wheels according to the present invention by which the production process according to the present invention is carried out.

Plant 1 comprises a building line 2, wherein each tyre is built by assembling structural components according to a predetermined sequence, and a moulding and vulcanization line 3, wherein each green tyre is moulded and vulcanized, within a respective vulcanization mould, thus becoming a finished product.

The building line 2 comprises a plurality of building stations 10 preferably arranged along a closed loop path indicatively represented by arrows 11 in FIG. 1.

Preferably, said building stations 10 operate simultaneously with each other, each on at least one tyre for assembling at least one of its structural components thereon.

It should be noted that in the present description and in the subsequent claims, by “structural component” of the tyre it is meant any component selected for example from: liner, sub-liner, carcass ply/plies, sub-belt insert, belt strips either crossing over one another or at zero degrees, attachment sheets for the tread band, tread band, rim, bead filler, textile or metallic reinforcing inserts, anti-abrasion insert, or any portion thereof.

In particular, during the building step the various structural components used for making each tyre are advantageously engaged on a toroidal support whose shape substantially reproduces the internal configuration of the tyre to be obtained. Such a toroidal support has a removable support shaft adapted for retaining the sectors of which the toroidal support is formed of. Such type of toroidal support collapsible or dismountable into a plurality of sectors, so as to be easily removed from the tyre when processing is completed, is for example described in document WO 01/62481 in the name of the Applicant.

Transfer devices 12 operate in the building line 2 for sequentially transferring each of the tyres being processed associated with a respective toroidal support from one of the building stations 10 to the next building station, so as to determine the sequential building of all the tyre components.

Preferably, such transfer devices 12 comprise one or more robotized arms associated with at least one of the building stations 10 and operating on the individual toroidal supports for transporting out the sequential transfer of each tyre being processed.

Referring now also to FIG. 2, it is shown that the vulcanization station 3 comprises a first vulcanization line 7A and a second vulcanization line 7B. Each vulcanization line 7A, 7B comprises a tyre moulding and vulcanization unit 4A, 4B.

According to the present invention, the vulcanization station 3 further comprises at least one holding unit 9 of toroidal supports which is operatively interposed between said first vulcanization line 7A and said second vulcanization line 7B so as to interact with both of them.

Said holding unit 9 is adapted for the temporary storage of the toroidal supports with or without the corresponding tyres between one operating step and the next one of the process according to the present invention.

Moreover, according to the present invention, the vulcanization station 3 comprises a first transfer device 8A, comprised in the first vulcanization line 7A, and a second transfer device 8B comprised in the second vulcanization line 7B.

Said first transfer device 8A is adapted for transferring a toroidal support between a moulding and vulcanization unit 4A of the first vulcanization line 7A of the tyre and the holding unit 9, whereas said second transfer device 8B is adapted for transferring a toroidal support between a moulding and vulcanization unit 4B of the second vulcanization line 7B of the tyre and the holding unit 9.

In the preferred embodiment shown in FIG. 2, both the first transfer device 8A and the second transfer device 8B, comprise a robotized arm moving on a track.

In particular, in such figure, there are shown a first track 15A on which the first transfer device 8A may move and a second track 15B on which the second transfer device 8B may move. As an alternative, it is possible to provide a first rail, or similar devices, on which the first transfer device 8A may move and a second rail, or similar devices, on which the second transfer device 8B may move.

In such embodiment, the holding unit 9 is parallel to the first track 15A and to the second track 15B and arranged symmetrically thereinbetween.

According to a preferred embodiment, the production plant 1 further comprises driving devices, not shown in the figure, for moving the first transfer device 8A and the second transfer device 8B during the process of the present invention.

The moulding and vulcanization units 4A, 4B comprise a moulding and vulcanization turntable 13 which is adapted for housing at least six vulcanization moulds 14, as shown in FIG. 2.

Preferably, the vulcanization moulds are mounted on a turntable to be driven in rotation so as to make the same vulcanization moulds transport out a closed-loop path, sequentially transporting them, one after the other, to a tyre loading/unloading station, each associated with its own toroidal support.

In this way, a green tyre, after having been loaded into a vulcanization mould, is subjected to a moulding and vulcanization process and, once the suitable time to complete the moulding and vulcanization operations has been achieved, is unloaded from the mould at the same loading/unloading station through rotation of the turntable.

The vulcanization moulds are preferably sealed airtight and are arranged to house a tyre being processed previously built on a toroidal support, the outer surface of which substantially reproduces the internal configuration of the tyre to be obtained. Said vulcanization moulds are provided with working fluid passage devices as illustrated for example in WO 2004/045837, in the name of the same Applicant.

As shown in FIG. 2, the first vulcanization line 7A comprises a unit 5A for removing the moulded and vulcanized tyre from the respective toroidal support and, accordingly, the second vulcanization line 7B comprises a removal unit 5B.

In this case, the first transfer device 8A is also adapted for transferring the toroidal support between the removal unit 5A of the first vulcanization line 7A and the holding unit 9; and the second transfer device 8B is also adapted for transferring the toroidal support between the removal unit 5B of the second vulcanization line 7B and the holding unit 9.

In the units 5A and 5B for removing the moulded and vulcanized tyre from the respective toroidal support, the toroidal support is dismounted so as to allow the removal of the moulded and vulcanized tyre therefrom and afterwards, it is remounted.

In the embodiment shown in FIG. 2, such operations are carried out by specific handling devices 11A, 11B, the first vulcanization line 7A and the second vulcanization line 7B of plant 1 are respectively provided with.

In particular, such handling devices 11A, 11B, may be assisted by further auxiliary handling devices (not shown) that comprise a mechanism adapted for removing and replacing a support shaft provided in the toroidal support, so as to allow the latter to be disassembled into a plurality of sectors and reassembled in its original operating shape.

Without such auxiliary handling devices, the first transfer device 8A and the second transfer device 8B are also adapted for transporting out one or more of the operations for dismounting the toroidal support in the removal unit 5A, 5B, such as the removal and the replacing of said support shaft from the toroidal support.

The vulcanization station 3 further advantageously comprises a cooling unit 6A, of the first vulcanization line 7A, and a cooling unit 6B, of the second vulcanization line 7B.

In this case, the first transfer device 8A is adapted for transferring said toroidal support among the moulding and vulcanization unit 4A, the removal unit 5A, the cooling unit 6A of the first vulcanization line 7A and the holding unit 9; and the second transfer device 8B is adapted for transferring said toroidal support among the moulding and vulcanization unit 4B, the removal unit 5B, the cooling unit 6B of the second vulcanization line 7B and the holding unit 9.

The cooling units 6A, 6B are adapted for cooling the toroidal to a temperature suitable for the tyre building process, for example such temperature may be comprised between about 40° C. and about 50° C. Once such temperature has been reached, the toroidal support is immediately ready for a new building process.

The production plant 1 is provided with one or more devices for moving the toroidal supports to and from the vulcanization station 3.

In particular, plant 1 comprises a first device 10A for moving the toroidal supports inside and outside the first vulcanization line 7A of the vulcanization station 3 and a second device 10B for moving the toroidal supports inside and outside the second vulcanization line 7B of the vulcanization station 3.

In other words, each of said moving devices 10A, 10B interacts with a single vulcanization line 7A, 7B, nevertheless, each of them may be set up for interacting also with the other vulcanization line 7A, 7B if needed.

As an alternative, each of said moving devices 10A and 10B may only be specialised for the input or the output of the toroidal supports from the vulcanization station 3.

It is also possible to provide that the transfers of the toroidal support within the vulcanization station 3 and/or the transfers of the toroidal supports outside the vulcanization station 3, are carried out by the first transfer device 8A and/or by the second transfer device 8B.

Preferably, the holding unit 9 is adapted for the temporary storage of at least two toroidal supports in output from the building line 2.

According to one preferred embodiment, said holding unit 9 is also adapted for the temporary storage of two or more toroidal supports in output from the moulding and vulcanization unit 4A, 4B, from the removal unit 5A, 5B, and from the cooling unit 6A, 6B of the first vulcanization line 7A or of the second vulcanization line 7B.

According to one embodiment of the present invention, the production plant 1 is provided with transport devices 16A, 16B adapted for transporting the moulded, vulcanized tyre removed from the toroidal support, outside the vulcanization station 3.

Preferably the moving devices 10, the devices for transporting the vulcanized tyres 16A, 16B and the handling devices 11A, 11B comprise a robotized arm or a conveyor belt.

In the embodiment shown in FIG. 2, the handling devices 11A, 11B comprise a robotized arm whereas the devices for transporting the vulcanized tyres 16A, 16B comprise a conveyor belt.

With reference to the production plant 1 illustrated in FIGS. 1 and 2, one preferred embodiment of a production process according to the invention shall now be described.

In accordance with a first step a), green tyres are assembled on respective toroidal supports assembling each structural component of each tyre according to a predetermined sequence at the above building stations 10 of the building line 2 of the production plant 1.

This building step of each tyre is carried out for example according to methods illustrated in document WO 01/32409, in the name of the same Applicant.

At the end of the building step, the tyre production process according to the present invention provides to transport out the following steps:

b) transferring a first green tyre and the relevant toroidal support to a moulding and vulcanization unit 4A of the first vulcanization line 7A of the vulcanization station 3 of the production plant 1, wherein said first vulcanization line 7A is provided with said first device 8A for transferring the toroidal support;

c) transferring a second green tyre and the relevant toroidal support to a moulding and vulcanization unit 4B of the second vulcanization line 7B of the vulcanization station 3 of the production plant 1, wherein said second vulcanization line 7B is different from the first vulcanization line 7A and is provided with said transfer device 8B, different from the first transfer device 8A.

Afterwards, the step of moulding and vulcanization the green tyres is carried out so as to define the structure of the tyres according to the desired geometry and tread pattern.

In particular, the next step d) provides the moulding and vulcanization of the first green tyre in the moulding and vulcanization unit 4A of the first vulcanization line 7A for a first time interval t1 and of the second green tyre in the moulding and vulcanization unit 4B of the second vulcanization line 7B for a second time interval t2, different from the first time interval t1.

This means that the process is carried out for vulcanization tyres that require different vulcanization times.

According to the present invention, at least one between steps b) and c), and preferably both, are preceded by a step j) of transporting one of said green tyres and the relevant toroidal support into a holding unit 9 operatively interposed between the first vulcanization line 7A and the second vulcanization line 7B.

In accordance with one preferred embodiment, after step d), the process comprises the step e) of transferring the moulded and vulcanized tyres with the respective toroidal supports in a respective tyre removal unit 5A, 5B of the respective vulcanization line 7A, 7B by the respective transfer devices 8A, 8B and then step f) of separating the moulded and vulcanized tyres from the relevant toroidal supports.

Such step e) may be preceded by a step j′) of transporting one of the moulded and vulcanized tyres and the relevant toroidal support into the holding unit 9.

Afterwards the toroidal supports are moved in a respective cooling unit 6A, 6B of the respective vulcanization line 7A, 7B by the respective transfer devices 8A, 8B, in accordance with a step g) and then cooled in accordance with a step h) that provides the cooling of the toroidal support to a temperature suitable for the tyre building process, preferably to a temperature substantially comprised between about 40° C. and about 50° C.

Also such step g) may be preceded by a step j″) of transporting one of the toroidal supports into the holding unit 9.

Once the toroidal supports have been cooled, during step h), step i) is carried out for moving the toroidal supports outside the respective vulcanization lines 7A, 7B of the vulcanization station 3. Also in this case it is advantageous if the transfer of said step i) is preceded by at least one of said steps j′), j″).

In other words, it is possible, and in some cases advantageous, if all the transfer steps b), c), e), g) and i) are preceded by a step of stand-by of the toroidal supports into the specific holding unit 9.

One or more of said steps b), c) and i) may be carried out by the specific device 10 for moving the toroidal supports to and from the vulcanization station 3, described above.

One or more of said steps b), c) and i), may also be carried by the transfer devices 8A, 8B.

According to a preferred embodiment, step b) is carried out by the first transfer device 8A and step c) is carried out by the second transfer device 8B.

Preferably, step f) comprises the following sequential steps:

f1) dismounting the toroidal support;

f2) removing the moulded and vulcanized tyre;

f3) remounting the toroidal support.

At least one of them is carried out by the aforementioned handling device 11A, 11B.

According to one preferred embodiment of the process according to the invention, the transfer devices 8A, 8B may also be set up for transporting out one or more of steps j), j′) and j″).

In accordance with one preferred embodiment, each of steps j), j′) and j″) comprises the following steps:

j1) transport of the first toroidal support in the holding unit 9 by means of the first transfer device 8A;

j2) transport of the second toroidal support in the holding unit 9 by means of the second transfer device 8B.

Advantageously, each of said steps j), j′) and j″) comprises the following steps:

j3) transport of the first toroidal support in one among the moulding and vulcanization unit 4A, the tyre removal unit 5A and the cooling unit 6A of the first vulcanization line 7A by means of the first transfer device 8A;

j4) transport of the second toroidal support in one among the moulding and vulcanization unit 4B, the tyre removal unit 5B and the cooling unit 6B of the second vulcanization line 7B by means of the second transfer device 8B.

Finally, it is possible to provide that said step i) is followed by a step k) of introduction of the toroidal support in the building line (2) for building a further tyre or for beginning a new production cycle starting from the above step a).

In the scope of the present previous description and the following claims, all the numerical measurements indicating quantity, parameters, percentages, etc, are to be considered as preceded by the term “about”, unless otherwise specified. Furthermore, all the intervals of numerical measurement include all the possible combinations of the maximum and minimum numerical values, as well as all the possible intermediate intervals, as well as those specifically indicated in the text.

1-44. (canceled)

45. A process for producing tyres for vehicle wheels comprising the steps of:
a) building green tyres on respective toroidal supports in at least one building line of a tyre production plant;
b) transferring a first green tyre and a toroidal support to a moulding and vulcanization unit of at least a first vulcanization line of a vulcanization station of the production plant, said first vulcanization line being provided with a first transfer device for transferring the toroidal support;
c) transferring a second green tyre and a toroidal support to a moulding and vulcanization unit of at least a second vulcanization line of the vulcanization station of the production plant, said second vulcanization line being different from the first vulcanization line and being provided with a second transfer device different from the first transfer device; and
d) moulding and vulcanizing the first green tyre in the moulding and vulcanization unit of the first vulcanization line for a first time interval and the second green tyre in the moulding and vulcanization unit of the second vulcanization line for a second time interval different from the first time interval;
wherein at least one of steps b) and c), is preceded by a step j) of transporting at least one of said green tyres and a toroidal support into a holding unit operatively interposed between said first vulcanization line and said second vulcanization line.

46. The process for producing tyres for vehicle wheels according to claim 45, further comprising the steps of:
e) transferring the moulded and vulcanized tyres with respective toroidal supports in a respective tyre removal unit of the respective vulcanization line by means of respective transfer devices; and
f) separating the moulded and vulcanized tyres from the respective toroidal supports.

47. The process for producing tyres for vehicle wheels according to claim 46, further comprising the steps of:
g) transferring the toroidal supports in a respective cooling unit of the respective vulcanization line by means of the respective transfer devices; and
h) cooling said toroidal supports in said cooling unit.

48. The process for producing tyres for vehicle wheels according to claim 46, wherein step e) is preceded by: j′) transporting one of said moulded and vulcanized tyres and toroidal support into a holding unit operatively interposed between said first vulcanization line and said second vulcanization line.

49. The process for producing tyres for vehicle wheels according to claim 47, wherein step g) is preceded by: j″) transporting one of said toroidal supports into a holding unit operatively interposed between said first vulcanization line and said second vulcanization line.

50. The process for producing tyres for vehicle wheels according to claim 47, comprising, after step h): i), transferring the toroidal supports outside the respective vulcanization lines of the vulcanization station.

51. The process for producing tyres for vehicle wheels according to claim 50, wherein step i) is preceded by at least one of the following steps:
j′) transporting one of said moulded and vulcanized tyres and a toroidal support into a holding unit operatively interposed between said first vulcanization line and said second vulcanization line; and
j″) transporting one of said toroidal supports into a holding unit operatively interposed between said first vulcanization line and said second vulcanization line.

52. The process for producing tyres for vehicle wheels according to claim 50, wherein at least one of steps b), c) and i) is carried out by at least one device for moving the toroidal supports to and from the vulcanization station.

53. The process for producing tyres for vehicle wheels according to claim 50, wherein at least one of steps b), c) and d) is carried out by said transfer devices.

54. The process for producing tyres for vehicle wheels according to claim 53, wherein step b) is carried out by means of the first transfer device and step c) is carried out by means of the second transfer device.

55. The process for producing tyres for vehicle wheels according to claim 46, wherein step f) comprises the following steps:
f1) dismounting the toroidal support;
f2) removing the moulded and vulcanized tyre; and
f3) remounting the toroidal support.

56. The process for producing tyres for vehicle wheels according to claim 55, wherein at least one of steps f1), f2) and f3) is carried out by a handling device.

57. The process for producing tyres for vehicle wheels according to claim 56, wherein at least one of steps f1) and f3) is carried out by said handling device assisted by an auxiliary handling device or by said transfer devices.

58. The process for producing tyres for vehicle wheels according to claim 47, wherein step h) comprises cooling the toroidal support to a temperature suitable for the tyre building process.

59. The process for producing tyres for vehicle wheels according to claim 58, wherein the toroidal support is cooled to a temperature of about 40° C. to about 50° C.

60. The process for producing tyres for vehicle wheels according to claim 45, further comprising:
j′) transporting one of said moulded and vulcanized tyres and a toroidal support into a holding unit operatively interposed between said first vulcanization line and said second vulcanization line; and
j″) transporting one of said toroidal supports into a holding unit operatively interposed between said first vulcanization line and said second vulcanization line, wherein at least one among said steps j), j′) and j″) is carried out by said transfer devices.

61. The process for producing tyres for vehicle wheels according to claim 60, wherein each of said steps j), j′) and j″) comprises the following steps:
j1) transporting the first toroidal support in said holding unit by means of the first transfer device; and
j2) transporting the second toroidal support in said holding unit by means of the second transfer device.

62. The process for producing tyres for vehicle wheels according to claim 60, wherein each of said steps j), j′) and j″) comprises the following steps:
j3) transporting the first toroidal support in one of the moulding and vulcanization unit, the tyre removal unit and the cooling unit of the first vulcanization line by means of the first transfer device;
j4) transporting the second toroidal support in one of the moulding and vulcanization unit, the tyre removal unit and the cooling unit of the second vulcanization line by means of the second transfer device.

63. The process for producing tyres for vehicle wheels according to claim 50, wherein step i) is followed by: k) introducing the toroidal support into said building line for building a further tyre.

64. A plant for producing tyres for vehicle wheels, comprising:
at least one building line for green tyres on respective toroidal supports;
at least one vulcanization station comprising:
a first vulcanization line and a second vulcanization line, each vulcanization line comprising at least one tyre moulding and vulcanization unit; and
at least one holding unit of toroidal supports operatively interposed between said first vulcanization line and said second vulcanization line;
at least a first transfer device in said first vulcanization line for transferring a toroidal support between said at least one moulding and vulcanization unit of said first tyre vulcanization line and said holding unit; and
at least a second transfer device in said second vulcanization line for transferring a toroidal support between said at least one moulding and vulcanization unit of said second tyre vulcanization line and said holding unit.

65. The plant for producing tyres for vehicle wheels according to claim 64, further comprising at least one removal unit for removing the moulded and vulcanized tyre from the respective toroidal support.

66. The plant for producing tyres for vehicle wheels according to claim 65, further comprising at least one cooling unit of said toroidal support.

67. The plant for producing tyres for vehicle wheels according to claim 65, wherein
said at least one first transfer device is capable of being adapted for transferring said toroidal support among at least two of said at least one moulding and vulcanization unit, said at least one removal unit of said first vulcanization line and said holding unit; and wherein
said at least one second transfer device is capable of being adapted for transferring said toroidal support among at least two of said at least one moulding and vulcanization unit, said at least one removal unit of said second vulcanization line and said holding unit.

68. The plant for producing tyres for vehicle wheels according to claim 66, wherein
said at least one first transfer device is capable of being adapted for transferring said toroidal support among at least two of said at least one moulding and vulcanization unit, said at least one removal unit, said at least one cooling unit of said first vulcanization line and said holding unit; and wherein
said at least one second transfer device is capable of being adapted for transferring said toroidal support among at least two of said at least one moulding and vulcanization unit, said at least one removal unit, said at least one cooling unit of said second vulcanization line and said holding unit.

69. The plant for producing tyres for vehicle wheels according to claim 64, wherein at least one of said first transfer device and said second transfer device is capable of being adapted for moving the toroidal support inside the vulcanization station.

70. The plant for producing tyres for vehicle wheels according to claim 64, wherein at least one of said first transfer device and said second transfer device is capable of being adapted for moving the toroidal support outside the vulcanization station.

71. The plant for producing tyres for vehicle wheels according to claim 64, further comprising at least one device for moving the toroidal supports to and from the vulcanization station.

72. The plant for producing tyres for vehicle wheels according to claim 71, comprising a first device for moving the toroidal supports inside and outside the first vulcanization line of the vulcanization station and a second device for moving the toroidal supports inside and outside the second vulcanization line of the vulcanization station.

73. The plant for producing tyres for vehicle wheels according to claim 64, wherein said holding unit is capable of being adapted for the temporary storage of at least two toroidal supports.

74. The plant for producing tyres for vehicle wheels according to claim 73, wherein said holding unit is capable of being adapted for the temporary storage of the toroidal supports in output from the building line.

75. The plant for producing tyres for vehicle wheels according to claim 73, wherein said holding unit is capable of being adapted for the temporary storage of the toroidal supports in output from at least one of said moulding and vulcanization unit, said removal unit, said cooling unit of the first vulcanization line or of the second vulcanization line.

76. The plant for producing tyres for vehicle wheels according to claim 64, further comprising transport devices capable of being adapted for transporting the moulded and vulcanized tyres, removed from the toroidal support outside the vulcanization station.

77. The plant for producing tyres for vehicle wheels according to claim 64, further comprising handling devices capable of being adapted for transporting out at least one of the following operations in the removal unit: dismounting of the toroidal support, removal of the moulded and vulcanized tyre from the toroidal support, and remounting of the toroidal support.

78. The plant for producing tyres for vehicle wheels according to claim 77, wherein auxiliary handling devices or said first and second transfer devices are capable of being adapted for carrying out the following operations in the removal unit: removing and replacing a support shaft provided in the toroidal support, so as to allow the toroidal support to be disassembled into a plurality of sectors and reassembled in its original operating shape by said handling devices.

79. The plant for producing tyres for vehicle wheels according to claim 64, wherein said moulding and vulcanization units comprise at least one moulding and vulcanization turntable.

80. The plant for producing tyres for vehicle wheels according to claim 79, wherein said moulding and vulcanization turntable comprises at least six vulcanization moulds.

81. The plant for producing tyres for vehicle wheels according to claim 68, further comprising at least one cooling unit of said toroidal support, wherein said cooling units are capable of being adapted for cooling the toroidal support to a temperature suitable for the tyre building process.

82. The plant for producing tyres for vehicle wheels according to claim 81, wherein said cooling units are capable of being adapted for cooling the toroidal support to a temperature of about 40° C. and about 50° C.

83. The plant for producing tyres for vehicle wheels according to claim 64, wherein at least one of the first transfer device, the second transfer device, the handling devices, the transport devices of the moulded and vulcanized tyres and the handling devices, comprises a robotized arm.

84. The plant for producing tyres for vehicle wheels according to claim 64, wherein at least one of the first transfer device, the second transfer device, the handling devices, the transport devices of the moulded and vulcanized tyres and the handling devices, comprises a conveyor belt.

85. The plant for producing tyres for vehicle wheels according to claim 64, further comprising at least a first rail for support of said first transfer device and at least a second rail for support of said second transfer device.

86. The plant for producing tyres for vehicle wheels according to claim 64, further comprising at least a first track for support of the first transfer device and a second track for support of the second transfer device.

87. The plant for producing tyres for vehicle wheels according to claim 64, further comprising driving devices for moving the first transfer device and the second transfer device.

88. The plant for producing tyres for vehicle wheels according to claim 86, wherein said holding unit is arranged between said first track and said second track.
